(19) United States
(12) Patent Application Publication
(10) Pub. No.: US 2003/0018522 A1
(43) Pub. Date: Jan. 23, 2003

(54) Biometric system and method for identifying a customer upon entering a retail establishment

(75) Inventors: Paul Denimarck, Webster, NY (US); Donald Bellis JR., Canandaiga, NY (US); Clarke McAllister, Eugene, OR (US)

Correspondence Address: PSC SCANNING, INC. - STOEL RIVES LLP, C/O STOEL RIVES LLP, 900 SW 5TH AVENUE, PORTLAND, OR, 97204, US

(73) Assignee: PSC Scanning, Inc.

(21) Appl. No.: 09/909,576

(22) Filed: Jul. 20, 2001

(51) Int. Cl. G06F 17/60; H04Q 1/00; H04B 1/00; H04B 3/00; G06F 7/00; G06F 7/04; H04Q 9/00; G05B 19/00; G06K 19/00; G08C 19/00; G05B 23/00; G08B 29/00; G08B 23/00; G08B 21/00; G08B 13/00

(52) U.S. Cl. 705/14; 340/5.82; 340/5.52; 340/500; 340/540; 340/541; 340/573.1

(57) ABSTRACT

A method of biometrically identifying a customer of a retail or non-retail establishment to facilitate or enhance the customer's shopping experience. The method includes obtaining a biometric profile representative of a biometric characteristic of a customer using a biometric sensing device; retrieving shopping history related information for the customer based on the biometric profile; and providing the customer with one or more items that facilitate or enhance the customer's shopping experience such as coupons, a shopping list, and/or a map showing the physical location of shopping list items in the retail establishment, the one or items based on the shopping history related information.

### BACKGROUND OF THE INVENTION

The field of the present invention relates to biometric systems and methods for identifying a customer upon entering a retail establishment to facilitate or enhance the customer's shopping experience.

U.S. Pat. No. 5,838,812 to Pare, Jr. et al. (“Pare”) describes a tokenless identification system and method in which a customer may present a pin number and a biometric characteristic, e.g., fingerprint, at checkout to pull associated payment information to pay for a commercial transaction at a retail establishment. A tokenless system such as this helps to eliminate having to carry credit cards, bank cards, cash, checks, etc.

Published European Patent Application 99307537.3 to Morrison, et al. (“Morrison”) describes a system and method in which a customer at a self-service checkout terminal may present a biometric characteristic at the terminal to verify his or her identity for an age-restricted purchase, e.g., sale of alcohol. This helps to eliminate having to carry personal identification such as a driver's license, passport, etc.

A problem with the systems and methods described in the Pare and Morrison references, which has been recognized by the present inventors, is that they wait until the customer is ready to leave the store before biometrically obtaining payment/personal information for checkout. This does nothing to enhance or facilitate the customer's pre-checkout shopping experience.

### SUMMARY OF THE INVENTION

The present invention in one aspect is directed to a method of biometrically identifying a customer of a retail establishment to facilitate or enhance the customer's shopping experience. The method includes obtaining a biometric profile representative of a biometric characteristic of a customer using a biometric sensing device; retrieving shopping history related information for the customer based on the biometric profile; and providing the customer with one or more items that facilitate or enhance the customer's shopping experience based on the shopping history related information. The one or more items may include coupons, a shopping list that may indicate the physical location of shopping list items in the retail establishment, and/or a map indicating the physical location of shopping list items in the retail establishment.

An additional aspect of the invention includes a system for biometrically identifying a customer of a retail establishment to facilitate or enhance the customer's shopping experience. The system includes a biometric sensing device adapted to convert a biometric characteristic of a customer of the retail establishment into a representative biometric profile, and a computer coupled to the biometric sensing device and adapted to retrieve shopping history related information for the customer based on the biometric profile and provide the customer with one or more items that facilitate or enhance the customer's shopping experience, the one or items based on the shopping history related information. In a preferred implementation of this aspect of the invention, the one or more items include one or more coupons, a shopping list that may indicate the physical location of shopping list items in the retail establishment, and/or a map indicating the physical location of shopping list items in the retail establishment.

Another aspect of the invention includes a method of registering a biometric characteristic and identifying a customer. The method includes registering a biometric characteristic of a customer by obtaining a biometric profile representative of a biometric characteristic of a customer using a biometric sensing device, obtaining payment information from the customer, associating and storing the biometric profile and payment information for the customer; and biometrically identifying the customer to facilitate or enhance the customer's shopping experience by obtaining a biometric profile representative of a biometric characteristic of a customer using a biometric sensing device, retrieving shopping history related information for the customer based on the biometric profile, providing the customer with one or coupons, a shopping list that may indicate the physical location of shopping list items in the retail establishment, and/or a map indicating the physical location of shopping list items in the retail establishment.

A further aspect of the invention involves a method of registering a biometric characteristic, identifying a customer, and checkout at a retail establishment. The method includes registering a biometric characteristic of a customer by obtaining a biometric profile representative of a biometric characteristic of a customer using a biometric sensing device, obtaining payment information from the customer, associating and storing the biometric profile and payment information for the customer; biometrically identifying the customer to facilitate or enhance the customer's shopping experience by obtaining a biometric profile representative of a biometric characteristic of a customer using a biometric sensing device, retrieving shopping history related information for the customer based on the biometric profile, providing the customer with one or more coupons, a shopping list that may indicate the physical location of shopping list items in the retail establishment, and/or a map indicating the physical location of shopping list items in the retail establishment to facilitate or enhance the customer's shopping experience; and biometrically checking out of the retail establishment by obtaining a biometric profile representative of a biometric characteristic of the customer using a biometric sensing device, retrieving payment information for the customer based on the biometric profile, and paying for one or more items using the payment information.

Other and further objects, features, aspects, and advantages of the present inventions will become better understood with the following detailed description of the accompanying drawings.

### BRIEF DESCRIPTION OF THE DRAWINGS

The following drawings illustrate both the design and utility of preferred embodiments of the invention. In the drawings, similar elements are referred to by common reference numbers.

FIG. 1 is a top plan view of an exemplary retail establishment with embodiments of a pair of biometric customer identification stations, four self-checkout stations, and a biometric registration station.

FIG. 2 is a top plan view of an embodiment of a biometric customer identification station.

FIG. 3 is a block diagram of an embodiment of a biometric customer identification system.

FIG. 4 is a perspective view of an embodiment of a self-checkout system.

FIG. 5 is a block diagram of an embodiment of a biometric registration system, a biometric customer identification system, and a biometric self-checkout system.

FIG. 6A is a top plan view of an embodiment of a combined biometric sensing and scanning device.

FIG. 6B is a top plan view of an embodiment of a combined biometric sensing and magnetic card reader device.

FIG. 7 is a schematic illustration of an embodiment of a computer that may be used in any or all of the systems illustrated in FIG. 2.

### DETAILED DESCRIPTION OF THE PREFERRED EMBODIMENTS

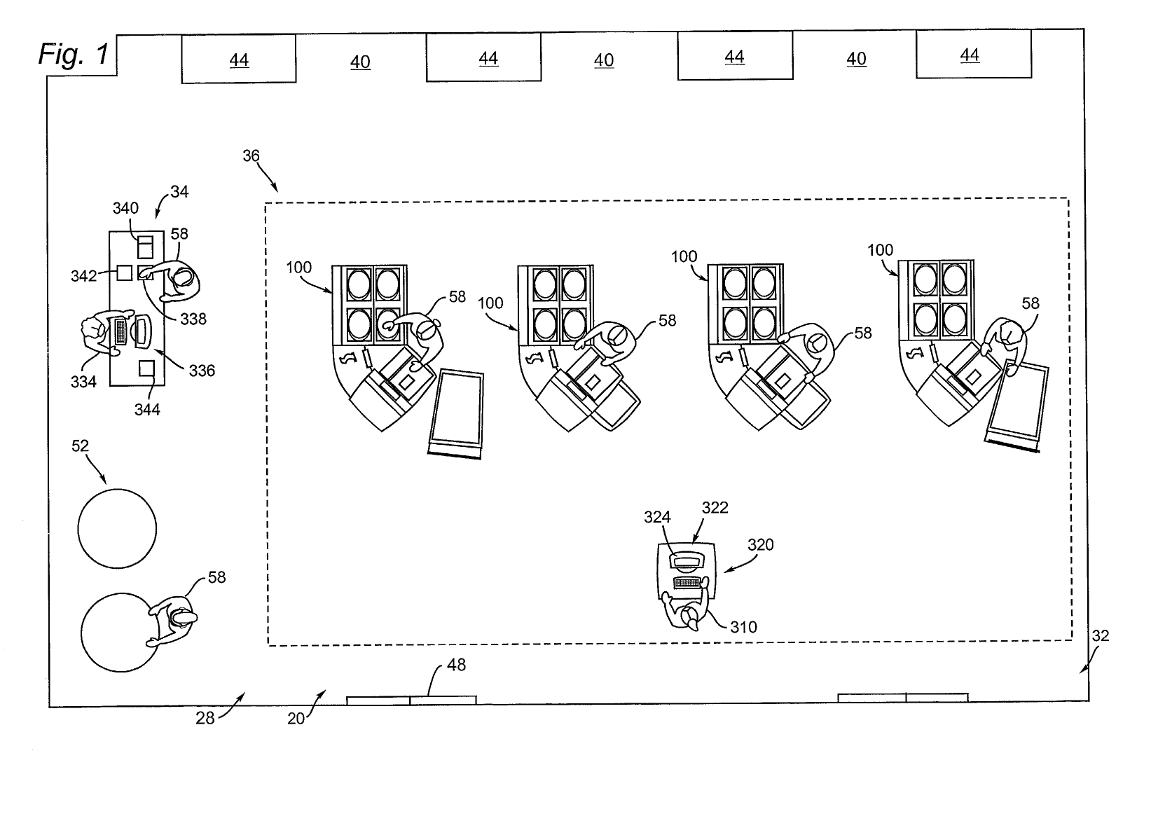

With reference to FIG. 1, the biometric systems and methods of the present invention are preferably used in a retail or commercial establishment 20 such as a grocery store. However, the biometric systems may be used in retail or commercial establishments other than a grocery store such as, but not by way of limitation, convenience stores such as 7-Eleven™, drug stores such as Walgreens™ or super drug stores such as F & M™, and mass merchants such as WAL-MART™, TARGET™, etc. The retail establishment 20 may include an entry area 28, an exit area 32, a customer service center 34, a checkout area 36, and aisles 40 defined by shelves 44 carrying retail goods.

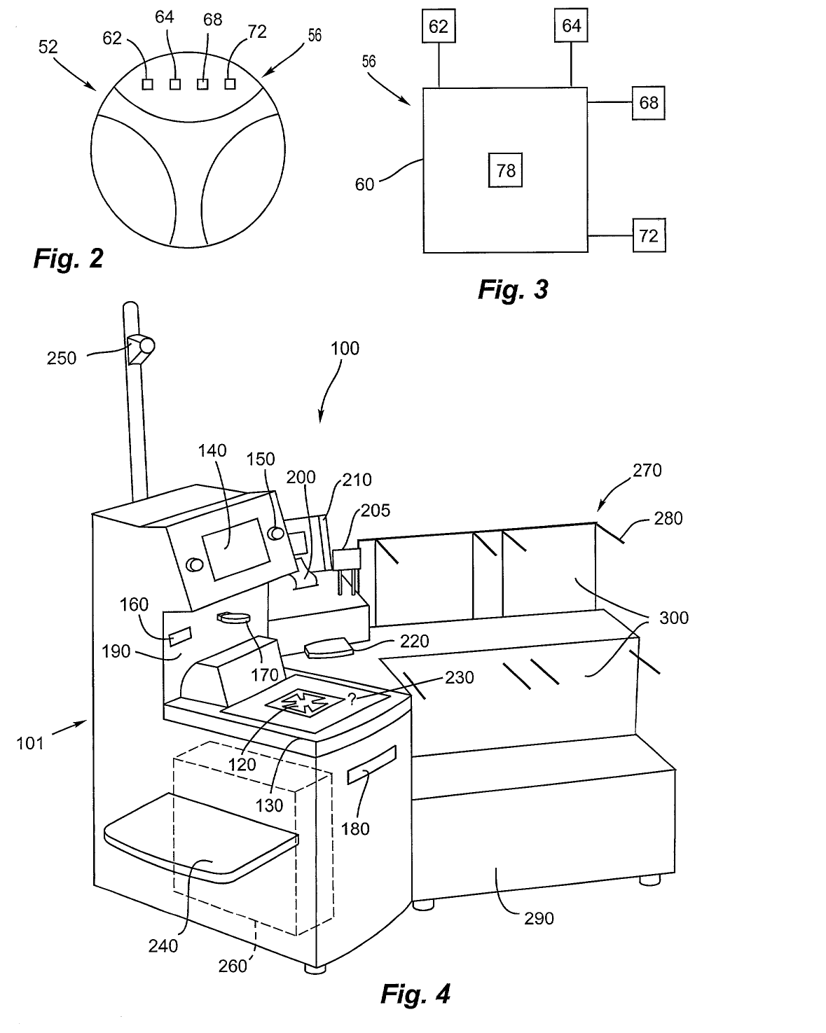

The entry area 28 is preferably adjacent to one or more entry doors 48, e.g., automatic sliding or rotating doors, of the retail establishment 20. The entry area 28 preferably includes one or more biometric customer identification kiosks or stations 52. With reference to FIGS. 2 and 3, each customer identification station 52 may include one or more biometric customer identification systems 56 for identifying a customer 58 upon entering the retail establishment. The system 56 preferably includes a computer or terminal 60. A separate terminal 60 may be provided for each system 56 or multiple systems 56 may share one or more terminals 60. The system 56 may include a touch-screen monitor or display 62 and one or more printers 64 coupled to the terminal 60 for printing out one or more coupons, a shopping list that may indicate the physical location of shopping list items in the retail establishment, and/or a map indicating the physical location of shopping list items in the retail establishment 20. A pin code entry device 68 and a biometric sensing device 72, which may be integrated, are preferably coupled to the terminal 60. The pin code entry device 68 and/or the biometric sensing device 72 may be integrated into the touch-screen monitor 62 through appropriate software. The pin code entry device 68 preferably includes a keypad for inputting a registered pin code for the customer 58. The biometric sensing device 72 is used to detect one or more unique biometric characteristics associated with the customer 58 for identifying the customer 58.

As used herein, a “biometric” characteristic is a substantially stable physical characteristic of a person which can be measured and characterized for comparison purposes. Examples of biometric characteristics include, but not by way of limitation, a fingerprint, a handprint, hand geometry, iris appearance, facial appearance, and speech/voice. Biometrics may also include behavioral characteristics such as the manner in which a person writes his or her signature.

The biometric sensing device 72 is preferably a fingerprint recognition device for detecting a fingerprint pattern associated with a customer's fingerprints. An example of a fingerprint recognition device that may be used is the Sony® Fingerprint Identification Unit (FIU-001/500) available from I/O Software, Inc. of Riverside, Calif. Such a device typically includes an optical system having a light sensor which captures a light pattern reflected from the customer's finger. The light pattern is converted by the device 72 into a fingerprint recognition profile that may be stored locally in memory 76 of the customer station terminal 60 or in memory of another computer.

Other types of biometric sensing devices 72 may be used instead of or in addition to a fingerprint recognition device. For example, the biometric sensing device 72 may be a facial recognition device for detecting a facial pattern or appearance associated with a customer's facial characteristics. Such a system typically includes a video system having a video camera (e.g., CCD camera) that captures an image of the customer. Thereafter, the image may be digitized or otherwise formatted and stored as a face recognition profile in any or all of memory locations described above.

The biometric sensing device 72 may be an iris recognition device for detecting an iris pattern associated with a customer's iris prints. Such a system typically includes an optical system having a light sensor which captures a light pattern reflected from the customer's iris. The light pattern may be stored as an iris recognition profile in any or all of the memory locations described above.

The biometric sensing device 72 may be a hand recognition device for detecting a hand pattern or geometry associated with a customer's hand characteristics. Such a system typically includes a video system having a video camera that captures an image of the customer's hand. The image is digitized or otherwise formatted and stored as a hand recognition profile in any or all of memory locations described above.

The biometric sensing device 72 may be a voice identification device for detecting a voice pattern or voiceprint associated with a customer's voice or speech characteristics. Such a system typically includes an audio system having a microphone which captures a sampling of the customer's voice. The sampling may be formatted and stored as a voice recognition profile in any or all of the memory locations described above.

Other biometric sensing devices 72 not described herein may also be used to obtain a biometric characteristic profile of a customer.

With reference to FIG. 4, an embodiment of a self-checkout station or system 100 may include a system housing 110 that houses or carries an identification code reader 120 (e.g., bar code scanner), a weighing scale 130, a touch screen LCD display 140, speakers 150, a bill acceptor 160, a coin dispenser 170, a bill dispenser 180, a coupon reader 190, a receipt printer 200, a biometric sensing device 205, an Electronic Funds Transfer (“EFT”)/magnetic strip card reader 210, a check reader/writer (MICR) 220, and a electronic article surveillance deactivator 230. A folding shelf 240 may be pivotally coupled to the housing 110 for temporary holding items to be purchased. A surveillance camera (e.g., CCD camera) 250 is preferably used to capture an image of or constantly view each of the items to be purchased and/or other self-checkout activity.

The system housing 110 preferably also houses a check-out terminal or computer 260 that, in order to control the system 100, may be coupled to the identification code reader 120, the weighing scale 130, the touch screen LCD display 140, the speakers 150, the bill acceptor 160, the coin dispenser 170, the bill dispenser 180, the coupon reader 190, the receipt printer 200, the biometric sensing device 205, the Electronic Funds Transfer (“EFT”)/magnetic strip card reader 210, the check reader/writer (MICR) 220, the electronic article surveillance deactivator 230 and monitor(s), and the surveillance camera 250 in a well-known manner.

A bagging station 270 may be adjacent to, connected to, or integral with the system housing 100. The bagging station 270 may include multiple bag support arms 280 extending therefrom for holding shopping bags. The bagging station 270 may include one or more scales 290 coupled to the checkout terminal 260 for weighing checked-out items to verify they weigh the same as the items scanned into the system 100. The bagging station 270 may also include one or more electronic article surveillance monitors 300 coupled to the self-checkout computer 260 for verifying that all the items have been scanned into the system 100.

With reference to FIG. 1, an attendant 310 preferably resides at an attendant station 320 positioned to strategically oversee customers 58 and self-checkout activity at the one or more self-checkout systems 100. The attendant station 320 may include an attendant computer system 322 including a monitor 324, and one or more input and output devices. In a preferred embodiment, one attendant 310 and attendant station 320 are provided for every four self-checkout systems 100. A retail establishment without self-checkout systems 100 typically has an attendant at each active checkout station. Thus, compared to a retail establishment without self-checkout systems 100, every four self-checkout systems 100 eliminates the need for three checkout employees. These employees may be utilized in other capacities, e.g., deli, assisting shoppers in selecting items, etc. In alternative embodiments, the number of self-checkout systems 100, attendant stations 320, and/or ratio of self-checkout systems 100 to attendants 310/attendant stations 320 may vary.

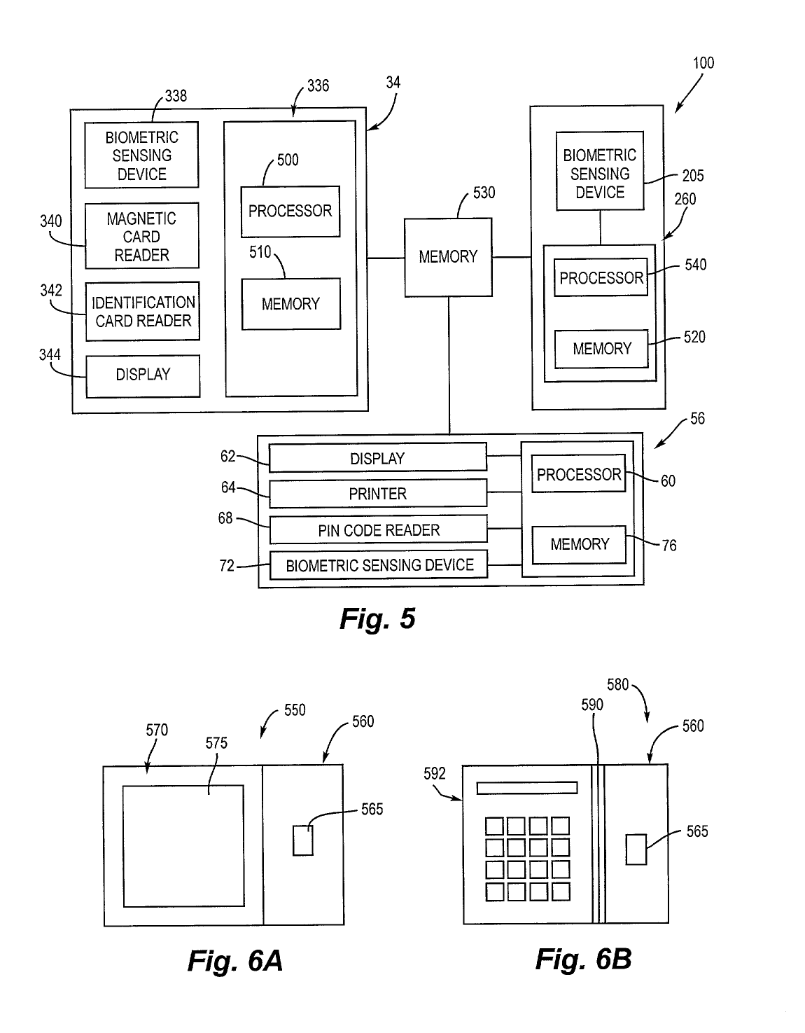

With reference to FIGS. 1 and 5, the retail establishment preferably also includes a customer service center or biometric registration station 34 run by a customer service center representative 334. The customer service center 34 may include a customer service center computer or terminal 336. A biometric sensing device 338 may be coupled to the computer 336. In alternative embodiments, a magnetic card reader 340 and/or an identification card reader 342 may also be coupled to the computer 336. The center 34 may also include a touch-screen display 344. The touch-screen display 344 may incorporate one or more of the biometric sensing device 338, magnetic card reader 340, and identification card reader 342. The center 34 also preferably includes a device for entering a customer pin code. This may be entered, for example, on a keypad of the magnetic card reader 340, biometric sensing device 338, or through the touch-screen display 344.

A biometric characteristic and pin code of a customer 58 may be registered using a biometric characteristic registration system at the customer service center 34. In one embodiment, the system includes a pin code entry device and the biometric sensing device 338 coupled to the computer 336. In alternative embodiments, the system also includes an input device such as the magnetic card reader 340 for obtaining customer payment information and/or or an input device such as the identification card reader 342 for obtaining customer personal information.

In alternative embodiments, a biometric characteristic of a customer 58 may be registered with one or more entities in addition to or other than the retail establishment. For example, a biometric characteristic may be registered with a chain of retail establishments 20 such as a chain of grocery stores, e.g., Krogers™, Safeway™, Giant™, Albertsons™, etc., a family of stores such as the Albertsons™ grocery store/Savon™ drug store family, or an organization responsible for the registration of biometric characteristics of customers 58.

The magnetic card reader 340 is preferably used to obtain customer payment information encoded on the magnetic strip of a payment card such as a credit card or electronic check cashing card. The payment information may be associated with the biometric characteristic profile obtained by the biometric sensing device 338 for the customer 58 and stored in any or all of the memory locations described above. As discussed above, the magnetic card reader 340 may include a keypad that can be used for entering a customer pin code to be associated with the payment information and biometric characteristic profile.

The identification card reader 342 may be used to obtain personal information on the customer 58 from a personal identification card, e.g., drivers license. The identification card reader 342 may be a scanner for scanning information from a front side of a customer's drivers license in order to obtain personal information therefrom. The identification card reader 342 may be a barcode scanner such as the identification code reader 120 illustrated in FIG. 4 for scanning a barcode on customer's drivers license in order to obtain personal information therefrom. The identification card reader 342 may also be a magnetic card reader capable of reading personal information encoded on a magnetic strip on the customer's personal identification card. If the identification card reader 342 is a magnetic card reader, the identification card reader 342 may be the same as or different from the magnetic card reader 340 described above.

With reference to FIG. 6A, a combined biometric sensing and scanning device 550 may be used to obtain biometric information and personal information from a user. The device 550 may include a biometric sensing mechanism such as a fingerprint recognition device 560 for detecting a fingerprint pattern associated with a customer's fingerprints. A user would place a finger face-down on a fingerprint window 565 to submit the biometric characteristic. Although a fingerprint recognition device 560 is shown, other biometric sensing devices such as those described above may be used. The device may also include an integrated barcode scanner 570 for scanning a bar code from a customer's drivers license through a scanner window 575 for obtaining personal information therefrom. The device 550 may obtain the fingerprint profile and the personal information, associate the information, and store the information in any or all of the memory locations described above. An advantage of the combined biometric sensing and scanning device 550 is that normally separate hardware, e.g., laser diodes, scanning mechanisms, mirrors, interfaces, etc. may be shared. The combined biometric sensing and scanning device 550 may be used at locations other than a customer service center and for purposes other than biometric characteristic and information registration. For example, the device 550 may be located at the self-checkout system and be used for registration purposes, scanning grocery items, paying for the groceries, and/or verifying the customer's identity.

With reference to FIG. 6B, a combined biometric sensing and magnetic card reader device 580 may be used to obtain biometric information and personal information from a user in a manner similar to that described above, except instead of scanning a barcode on a drivers license to obtain personal information, a magnetic strip on the drivers license is swiped through a magnetic card reader 590. The magnetic card reader 390 may also be used to obtain payment information encoded on the magnetic strip of a token such as a credit card, cash card, etc. The device may also include a keypad 592 for inputting any type of pin code or for other input purposes.

In another embodiment, a biometric sensing device, a magnetic card reader, and a barcode scanner may be integrated into a single device. Also, the biometric sensing device and keypad may be incorporated into a touch-screen display through appropriate software.

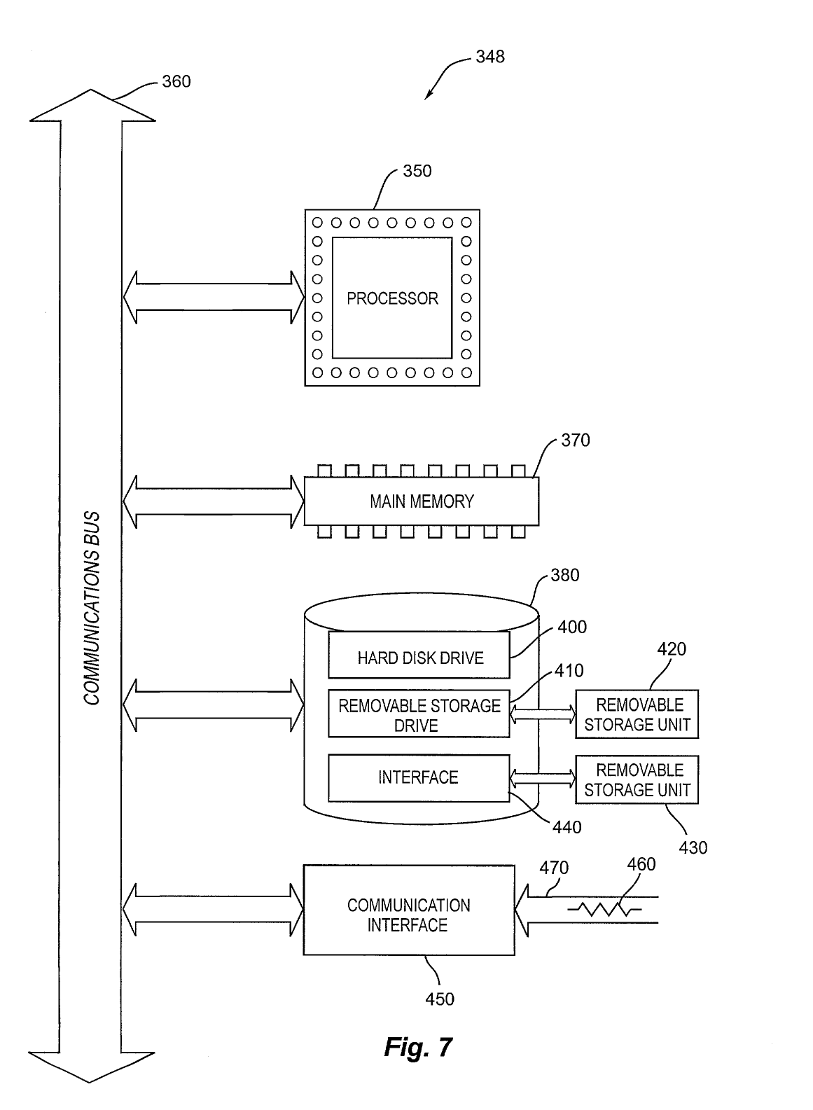

With reference to FIG. 7, an embodiment of an exemplary computer 348 that may be used as the computer station terminal 56, the self-checkout system computer 260, the customer service center computer 336, the attendant computer 324 or any other computer discussed herein will now be described. The system may also be implemented using other computer systems and/or computer architectures. The computer 348 may include hardware, software or a combination thereof and may be implemented in one or more computer systems or other processing systems.

The computer 348 may include one or more processors such as processor 350. The processor 350 is connected to a communication bus 360. The computer 348 also includes a main memory 370, preferably random access memory (RAM), and can also include a secondary memory 380.

The secondary memory 380 can include, for example, a hard disk drive 400 and/or a removable storage drive 410, representing a floppy disk drive, a magnetic tape drive, an optical disk drive, etc. The removable storage drive 410 reads from and/or writes to a removable storage unit 420 in a well-known manner. Removable storage unit 420, represents a floppy disk, magnetic tape, optical disk, etc. which is read by and written to by removable storage drive 410. As will be appreciated, the removable storage unit 420 includes a computer usable storage medium having stored therein computer software and/or data.

In alternative embodiments, secondary memory 380 may include other similar means for allowing computer programs, other instructions, or data to be loaded into the computer system 260. Such means can include, for example, a removable storage unit 430 and an interface 440. Examples of such can include a program cartridge and cartridge interface (such as that found in video game devices), a removable memory chip (such as an EPROM, or PROM) and associated socket, and other removable storage units 430 and interfaces 440 which allow software and data to be transferred from the removable storage unit 430 to computer system 348.

The secondary memory 380 may include memory 510, 520, and/or 530 described above for storing biometric information, payment information, and/or personal information for multiple customers 58.

The computer 348 may also include a communications interface 450. The communications interface 450 allows software and data to be transferred between the computer 348 and external devices. Examples of communications interfaces 450 include, but not by way of limitation, a modem, a network interface (such as an Ethernet card), a communications port, a PCMCIA slot and card, etc. Software and data transferred via the communications interface 450 are in the form of signals 460 which can be electronic, electromagnetic, optical or other signals 460 capable of being received by communications interface 450. These signals 460 are provided to communications interface 450 via a channel 470. This channel 470 carries signals 460 and can be implemented using wire or cable, fiber optics, a phone line, a cellular phone link, an RF link and other communication channels 470.

In this document, the terms “computer program medium” and “computer usable medium” are used to generally refer to media such as removable storage unit 420, 430, a hard disk installed in hard disk drive 400, and signals 460. These computer program products are means for providing software and data to computer system 348.

Computer programs (also called computer control logic) may be stored in main memory 370 and/or secondary memory 380. Computer programs can also be received via communications interface 450. Such computer programs, when executed, enable the computer system 348 to perform the features of the system as discussed herein. In particular, the computer programs, when executed, enable the processor 350 to perform the features of the system. Accordingly, such computer programs represent controllers of the computer system 348.

In an embodiment where the system is implemented using software, the software may be stored in a computer program product and loaded into computer system 348 using removable storage drive 410, hard drive 400, or communications interface 450. The control logic (software), when executed by the processor 350, causes the processor 350 to perform the functions of the system as described herein.

In another embodiment, the system is implemented primarily in hardware using, for example, hardware components such as application specific integrated circuits (ASICs), a set of wired logic circuits, or an old-fashioned hardwired circuit of transistors, capacitors, and resistors.

In yet another embodiment, the system is implemented using a combination of both hardware and software.

With reference to FIGS. 1-5, a method of registering a biometric characteristic of a customer 58, a method of identifying a customer 58 upon entering the retail establishment 20, and a method of paying for one or more items checked out in a self-checkout system 100 with a biometric characteristic of a customer 58 will now be described.

A customer 58 registers a biometric characteristic and a customer pin code with payment information at the biometric registration station 34 (FIGS. 1, 5) by, first, having the biometric sensing device 338 detect a biometric characteristic of the customer 58. In the embodiment of the biometric sensing device 338 shown, which is a fingerprint recognition device, the customer places his or her finger face down on the fingerprint recognition device and the fingerprint recognition device captures a light pattern reflected from the customer's finger and converts the light pattern into a storable fingerprint recognition profile.

Next, the customer 58 may provide payment information by, for example, sliding a credit card or electronic check cashing card through the magnetic card reader 340. The magnetic card reader 340 reads encoded information in the magnetic strip on the card and converts and formats the information into a storable form. The payment information may include any information needed to process a future payment transaction, e.g., a credit card number, banking account number, routing number, a customer name, an expiration date, etc. If a combined biometric sensing and magnetic card reader device 580 such as that illustrated in FIG. 5B is available, biometric information and payment information may be registered using the same device. A customer pin code is also preferably provided using the magnetic card reader through a keypad.

Payment information for the customer 58 may be obtained in other ways. For example, the customer 58 may enter the payment information manually into the computer 336 or another computer via an input device such as a keyboard/mouse. Alternatively, the customer 58 may be asked to fill out a payment information form. The customer service center representative 334 or another person may then enter the customer payment information manually via an input device such as a keyboard/mouse or automatically by, for example, a scanning and character recognition process. Payment information may be obtained via other ways such as, but not by way of limitation, by an electronic check reading process. The payment information and customer pin code may be associated with the biometric information for the customer by a processor 500 (FIG. 5) of the customer service center computer 336 and stored in memory 76, 510, 520, and/or 530.

Personal information for the customer 58 may also be obtained at the customer service center 34. The personal information for customer 58 may be associated and stored with the biometric information, payment information, and customer pin code. For example, a personal identification card such as a drivers license of the customer's may include a magnetic strip with personal information encoded therein. The magnetic strip may be read by the magnetic card reader 340 or the identification card reader 342. The identification card reader 342 may be a scanner so that information from the front face of a customer's personal identification card or a barcode from the customer's personal identification card may be scanned and the information stored in memory 510, 520, and/or 530. Personal information may be obtained in other ways such as, but not by way of limitation, those described above for obtaining payment information. Personal information may include any type of information needed to process a future payment transaction or other desirable information to have associated with the biometric information for the customer, e.g., the customer's name, age, birth date, address, telephone number, e-mail address, etc. If a combined biometric sensing and scanning device 550 such as that illustrated in FIG. 6A is available, biometric information and personal information may be registered using the same device.

Although the biometric information, payment information, customer pin code, and personal information have been described as being obtained at the customer service center 352 in a particular order, this information may be obtained in any order. Also, customer 58 may supply this registration information at a location other than the customer service center 34 such as, but not by way of limitation, at the customer identification stations 56, self-checkout system 58, at the attendant station 320, or at a self-registration station. For example, if the biometric sensing device 205 is used to obtain a biometric characteristic of the customer 58, the magnetic card reader 210 is used to obtain payment and pin code information, and the identification card reader 120 is a barcode scanner and used to obtain personal information from a barcode of a customer's drivers license, registration may occur at the self-checkout system 100. Biometric customer registration may also occur at the customer identification stations 56. In addition to the devices described, the customer identification stations 56 may also include a magnetic card reader for obtaining payment information and a customer pin code. The magnetic card reader may include the pin code entry device 68 described above with respect to FIGS. 2 and 3. The station 56 may also include an identification card reader.

A method of identifying a customer at one of the customer identification stations 56 will now be described. A customer 58 enters the retail establishment 20 and approaches a customer station 56 (FIGS. 1-3). The customer 58 is identified by entering a pin code into the pin code entry device 68 and providing a biometric characteristic, e.g., thumbprint, to the biometric sensing device 72. A customer record is obtained based on one or more queries including the submitted pin code and biometric characteristic profile. The terminal 60 may prompt the customer via the display 72 of one or more customer options once the customer is identified. One option may be to print one or more shopping coupons (e.g., manufacturers coupon, retail establishment coupon) for the customer's use. The type of shopping coupons and amount may be based on, for example, one or more of the following: the shopping history of the customer, the time of day, the day of the week, the season, the weather, regional preferences, goods in excess supply, goods with an approaching expiration date, etc. Upon selection of this option, one or more relevant coupons may be printed by the printer 64.

Another option may be to display a grocery or shopping list or to create a grocery list. Upon selection of this option, a pull-down grocery list may appear. The grocery list may be based on the customer's shopping history and/or may be based on current inventory. The grocery list may be organized by subject matter, e.g., produce, meats, by alphabetical order of the generic type of each good, brand name, etc. After all of the items for the grocery list have been identified, which is preferably done via the touch-screen display 62, the grocery list may be printed using the printer 64. The printer 64 may be replaced or supplemented with a communication device such as an infrared port for communicating information such as the coupons or the grocery list with a portable computing or electronic device such as a Personal Digital Assistant (“PDA”) such as a PalmPilot®. The customer 58 may then use the grocery list and/or coupons to assist in the customer's shopping decisions in the retail establishment 20.

A further option, after the grocery list is determined, may be to generate a store map showing the physical location of grocery list items in the retail establishment 20, i.e., a store map showing the physical location in a aisle, end cap, etc. where grocery list items are located. Alternatively or additionally, the grocery list described above may indicate the physical location, e.g., aisle, end caps, etc., where grocery list items are located.

One or more computers or terminals in the retail establishment 20 may communicate with the customer identification station 52 so that employees of the retail establishment 20 may obtain a customer's grocery list information to facilitate or enhance the customer's shopping experience. This may be done, for example, by one or more store employees pulling “low-touch” items (e.g., staple items that require no thought or decision making such as milk, orange juice, cereal, etc.) from a customer's grocery list off the shelves for the customer 58. Employees stationed in various “low-touch” areas of the store would know what a customer 58 is planning on purchasing and have those products pulled before the customer 58 ever arrived at the particular “low-touch” areas of the store. This would help to reduce the customer's total shopping time and allow the customer 58 more time to select “high-touch” grocery list items (e.g., items that may require hand picking such as produce, meats, wine, etc.). The extra employees that would normal reside at checkout eliminated by use of the self-checkout systems 100 (e.g., three employees for every four self-checkout systems 100 in the exemplary checkout area 36 of FIG. 1) could be reallocated to pulling “low-touch” grocery list items for customers 58 in “low-touch” areas of the retail establishment.

Thus, a key benefit of customer identification at a customer identification station 52 is Customer Relationship Management (“CRM”). By knowing what the customer wants and/or a customer's shopping history, the retail establishment 20 can determine how to facilitate and enhance the customer's shopping experience.

After the customer 58 has selected all of the shopping items, the customer proceeds to the checkout area 36, which includes one or more of the self-checkout systems 100 (FIGS. 1, 4). The display 140 preferably displays instructions that serve to guide the customer 58 through a checkout procedure. The display 140 is preferably a touch-screen display that can generate data signals when certain areas of the screen are touched by the customer 58. The display 140 may instruct the customer 58 to begin by scanning multiple items. The customer 58 scans the identification code, e.g., bar code, of each item being purchased with the identification code reader 120.

In a preferred embodiment, the identification code reader 120 is a fixed bar code scanner with a horizontal scanner window and substantially vertical scanner window. The bar code of each item is scanned or read by placing the item in front of or over a scanner window, the bar code facing the window. The preferred reader 120 for high-volume checkout is a multi-window scanner such as the Magellan® scanner-scale available from PSC Inc. of Eugene, Oreg. Although not shown, the scanner may include a light source such as a laser, a rotating mirror driven by a motor, and a mirror array. In operation, a laser beam reflects off the rotating mirror and mirror array to produce a pattern of scanning light beams. As the product identification code on an item is passed over the scanner, the scanning light beams scatter off the code and are returned to the scanner where they are collected and detected. The reflected light is then analyzed electronically in order to determine whether the reflected light contains a valid product identification code pattern. If a valid code pattern is present, identification information such as the SKU value for the item may be determined. The system 100 may acknowledge successful identification of a valid code pattern by an audible beep or other sign. The price for the identified item may be retrieved from a separate database.

Examples of product identification codes that may be read include Universal Product Codes (UPC), i.e., bar codes, industrial symbols, alphanumeric characters, or other indicia associated with an item to be purchased.

A preferred fixed scanner for a high-volume location such as a grocery store checkout is a multi-scan window scanner such as the Magellan® scanner available from PSC Inc. of Eugene, Oreg.

In an alternative embodiment, the reader 120 is a hand-held scanner or other type of portable reader that may be moved to read the identification code of the item in a manner similar to that described above.

Preferably after identification and price information for an item is determined, a security verification process may be performed to verify that the items actually being checked out or removed from the store are the same items as those being read or scanned into the system 100. Otherwise, for example, a customer 58 may, for example, scan an inexpensive item or items, e.g., beans, multiple times while removing a more expensive item or items, e.g., steaks.

In a preferred embodiment, the security verification mechanism includes one or more of the scales 290 and the security verification process is a weighing process. However, in alternative embodiments an electronic scale and weighing process may be replaced or supplemented with other security verification mechanisms and procedures. For example, an image or images of an item from the surveillance camera 250 may be used by the attendant 310 to verify that the items being checked out or removed match those that are being scanned. The surveillance camera 250 or other image capturing device could be used to capture dimensional information for each item being checked out and this dimensional information could be compared to dimensional information associated with the SKU values for the items scanned for security verification purposes.

After scanning an item or multiple items, the item(s) is placed on the electronic scale(s) 290. A weight for the item(s) is determined by the difference between the weight on the scale 290 before the item(s) was placed on the scale 290 and the weight on the scale 290 after the item(s) was placed on the scale 290. The weight is compared to weight information for the item(s) scanned to determine if the weight of the item on the scale 130, i.e., the item(s) actually being removed or checked out from the store match the weight information of the item(s) scanned.

Preferably, as the weight of each item is verified, the system 100 will acknowledge security verification with an audible beep or other sign. After or prior to security verification, a subtotal/total may be calculated and displayed on the display 140 and/or broadcasted via the speakers 150.

If security verification is unsuccessful, the attendant 310 may be notified. The customer 58 may then be instructed to put the scanned item on the scale 130, which is preferably integrated with the reader 120, and the attendant 310 is requested to verify that the item on the scale 130 is truly what the customer 58 scanned. If the attendant 310 verifies that the item scanned is the item on the scale 130, this new weight may be accepted into a weight look-up database and the attendant 310 may ask the customer 58 to put the item on the security bagging scale 290. The attendant 310 may want to override the security scale violation instead of letting the customer 58 go through the re-weigh activity described above. The attendant can do that by touching an “override” portion of the display 140 so that the customer 58 does not have to remove and weigh the item. Data from the security bagging scale 290 is preferably not accepted as weight input into the weight look-up database.

The items being checked out may include a magnetic tag, RFID tag, electronic tag or other tag to prevent the items from being removed from the retail establishment 20 without properly checking the items out. If an item is properly scanned, the electronic article surveillance deactivator 230 may be actuated, causing a deactivating coil to be energized and the tag on the item to be deactivated or removed. If an item was not properly scanned, the tag is sensed by the electronic article surveillance monitor 300. The customer 58 may then be prompted to re-scan the item. If scanning is successful, the tag will be deactivated or removed.

After all the items have been scanned and weight verified, the customer 58 may present coupons such as those issued at the customer identification station 56 for scanning by the coupon reader 190. As indicated above, the coupons may be electronic coupons. The coupon reader 190 may include a communication device for reading electronic coupons, e.g., an infrared port for communicating coupon information from a portable computing or electronic device with the system 100. The electronic coupons may also include displayed bar codes from the computing or electronic device (e.g., PDA) that may be read with the reader 120. The customer 58 may then request the final bill by, for example, selecting an appropriate input on the touch screen display 140, making a voice request recognized by a voice recognition mechanism of the system 100, or performing some other bill requesting act with respect to an input device. In response to the customer's request, the total purchase price is displayed on the display 140, the customer tenders payment to the checkout system 100, and the bill is printed out by the receipt printer 200.

The customer 58 may tender payment by placing his or her finger face down on the biometric sensing device 210, which in the embodiment of FIGS. 1 and 4 is a fingerprint recognition device, and the fingerprint recognition device captures a light pattern reflected from the customer's finger and converts the light pattern into a fingerprint recognition profile. Other types of biometric sensing devices 338 such as, but not limited to, any of those described above with respect to the registration system may be used instead of or in addition to the fingerprint recognition device. A processor 540 (FIG. 5) of the self-checkout computer 260 may query memory 76, 510, 520, and/or 530 to obtain payment information associated with a matching stored fingerprint recognition profile of the customer 58. As used herein, “match”, “matches”, or “matching” means the same as or within a predetermined tolerance range. If a matching fingerprint recognition profile and associated payment information for the customer 58 is successfully retrieved, the system 100 may acknowledge this with a distinctive audible beep from the speakers 150 or some other sign, and the retrieved payment information may be used for payment processing. If a clear fingerprint read is not obtained or a positive match does not occur, the system 100 may indicate such with a distinctive audible beep from the speakers 150 or some other sign. If the customer 58 was identified previously at the customer identification station 56, this information is preferably temporarily stored in memory 76, 510, 520, and/or 530 for quick retrieval during the self-checkout process. If the customer 58 was not identified at the customer identification station 56, the customer 58 may be prompted to enter a pin code in addition to the biometric characteristic to facilitate retrieving customer information. The customer 58 may then be instructed accordingly via the display 140 and/or the speakers 150.

If the biometric sensing device 210 is unable to obtain a clear reading of the customer's fingerprint, a positive fingerprint recognition match is not made, if the customer's biometric and payment information has not been registered, or the customer prefers to usual more traditional form of payment, the self-checkout system 100 may accept more traditional types of payment such as cash payment via the bill acceptor 160, credit card or cash card payment via the Electronic Funds Transfer (“EFT”)/magnetic strip card reader 210, or check payment via the check reader/writer (MICR) 220. If the customer 58 makes a cash payment or desires cash back for a check, debit card, or credit card, the system 100 may dispense change via the bill dispenser 180 and coin dispenser 170. If a check, debit card, or credit card is used, the customer 58 may be prompted to verify his or her identify through a biometric characteristic of the customer 58, driver's license, or ID card.

If the customer 58 is checking out an age-restricted item such as tobacco products, alcoholic beverages, certain solvents, fireworks, publications, or other age-restricted items, an ID check may be required. The self-checkout computer 260 may determine that an age-restricted item has been read, and the customer may be prompted via visual instructions on the display 140 or audible instructions via the speakers 150 that an identification check is required. At this point, the customer 58 may place his or her finger face down on the biometric sensing device 210, which in the embodiment of FIG. 4 is a fingerprint recognition device, and the fingerprint recognition device captures a light pattern reflected from the customer's finger and converts the light pattern into a fingerprint recognition profile. The processor 540 of the self-checkout computer 260 may then query memory 510, 520, and/or 530 to obtain personal information such as age information of the customer associated with a matching stored fingerprint recognition profile of the customer 58. Based on the age information retrieved or calculated from present date and retrieved date of birth for the customer, the processor 540 may determine whether the age restriction for the item is met. If the age restriction for the item is met, the system 100 may acknowledge this with a distinctive audible beep from the speakers 150 or some other sign. If a clear fingerprint read is not obtained, a positive fingerprint recognition match does not occur, the customer 58 was not previously identified at the customer identification station 56, and/or the age restriction for the item is not met, the system 100 may indicate such with a distinctive audible beep from the speakers 150 or some other sign. The customer 58 may then be instructed accordingly via the display 140 and/or the speakers 150. Further, the attendant 310 may be signaled to verify the age of the customer 58 or retrieve the age-restricted item from the customer 58. This age verification process may be required after each age-restricted item is scanned, after multiple age-restricted items are scanned, or after all items to be purchased have been scanned.

Another option at the self-checkout system 100 is for the customer 58 to receive cash back. The customer 58 may be prompted for this option after a total for all items has been calculated. If the customer 58 selects this option, the customer 58 may be prompted to select an amount, e.g., $20, $40, $60, etc. for cash back or the customer 58 may be able to enter another amount up to a predetermined limit. The payment amount charged would be the cash back amount plus the total for all items to be purchased. For example, if a customer 58 purchased $32.32 in groceries and opted for $60 cash back, the customer 58 would be charged a payment amount of $92.32. The customer 58 could tender the payment amount by any of the payment methods described above, e.g., through a biometric characteristic and associated account, ATM card, credit card, or check. The customer may be charged one or more transaction fees for obtaining cash back. For security and fraud-prevention purposes, the self-checkout system 100 may require verification of a customer's identification if cash back is requested and the customer 58 tenders payment with a check, debit card, or credit card. The customer 58 may be prompted to verify his or her identify through a biometric characteristic of the customer 58, driver's license, or ID card.

Once the bill has been paid and the receipt issued, the self-checkout transaction is finished, and the customer 58 can leave the store 20.

Although the checkout process has been described as a self-checkout process, in an alternative embodiment, the checkout process may be performed with a checkout clerk.

Thus, the biometric identification, registration and self-checkout systems provide one or more of the following advantages:

facilitate and enhance the customer's shopping experience by providing the customer with valuable coupons and/or a shopping list;

facilitate and enhance the customer's shopping experience by generating a store map showing the physical location of shopping list items and/or organized list indicating which shopping list items are in each aisle, end cap, etc.

facilitate and enhance the customer's shopping experience by identifying a customer's shopping list items during the customer identification step so that store employees can assist in pulling “low-touch” shopping list items such as milk, orange juice, and cereal off the shelf for the customer, allowing the customer to focus on hand-picking “high-touch” items such as produce, meats, and wine;

speed up the self-checkout process because the customer has already been identified during the identification step;

eliminate the need to carry credit cards, check cards, cash, checks, etc. for retail or non-retail establishment purchases;

eliminate the need to carry identification cards, e.g., drivers license, for age-restricted retail or non-retail establishment purchases;

reduce or eliminate the need for an employee such as the customer service manager or attendant to be readily available at or near the self-checkout system in order to verify the age of a customer upon entry of a restricted item, thereby reducing labor costs associated with the retailer's operation and/or labor time of such an employee that normally would be responsible for this verification process;

increase throughput of the self-checkout system and enhance customer convenience by eliminating need for the customer service manager or attendant to verify the customer's age;

reduce or eliminate the need for checkout employees because one attendant oversees multiple self-checkout systems, allowing employees not needed at checkout to be used for other purposes such as pulling “low-touch” items from the shelves for customers that presented their shopping list during the customer identification step;

make the retail establishment less sensitive to labor shortages and still maintain high levels of checkout service because one attendant can effectively oversee multiple self-checkout systems without the need for other employees.

Although the present invention has been described above in the context of certain preferred embodiments, it is to be understood that various modifications may be made to those embodiments, and various equivalents may be substituted, without departing from the spirit or scope of the invention.

What we claim is:

1. A method of biometrically identifying a customer of a retail establishment to facilitate or enhance the customer's shopping experience, comprising:
obtaining a biometric profile representative of a biometric characteristic of a customer using a biometric sensing device;
retrieving shopping history related information for said customer based on said biometric profile;
providing the customer with one or more items that facilitate or enhance the customer's shopping experience, the one or items based on the shopping history related information.

2. The method of claim 1, wherein said one or more items include one or more manufacturer or retail establishment coupons.

3. The method of claim 2, wherein said coupons are physical, printed coupons.

4. The method of claim 2, wherein said coupons are electronic coupons.

5. The method of claim 1, wherein said one or more items include a personal shopping list.

6. The method of claim 5, wherein said personal shopping list is a physical, printed shopping list.

7. The method of claim 5, wherein said personal shopping list is an electronic shopping list.

8. The method of claim 5, wherein physical locations of items of said personal shopping list in the retail establishment are shown in a retail establishment map.

9. The method of claim 5, wherein said personal shopping list includes location information indicating where in a retail establishment items of said personal shopping list are located.

10. The method of claim 5, further including the step of using said personal shopping list and/or said shopping history related information to provide customer relationship management.

11. The method of claim 10, wherein customer relationship management includes pulling low-touch items of said personal shopping list from shelves of the retail establishment for a customer.

12. The method of claim 1, wherein said biometric sensing device includes a fingerprint recognition device, and the step of obtaining includes obtaining a biometric profile representative of a customer's fingerprint.

13. The method of claim 1, wherein said biometric sensing device includes a hand geometry recognition device, and the step of obtaining includes obtaining a biometric profile representative of a customer's hand geometry.

14. The method of claim 1, wherein said biometric sensing device includes a handprint recognition device, and the step of obtaining includes obtaining a biometric profile representative of a customer's handprint.

15. The method of claim 1, wherein said biometric sensing device includes an iris recognition device, and the step of obtaining includes obtaining a biometric profile representative of a customer's iris.

16. The method of claim 1, wherein said biometric sensing device includes a face recognition device, and the step of obtaining includes obtaining a biometric profile representative of a customer's facial appearance.

17. The method of claim 1, wherein said biometric sensing device includes a voice or speech recognition device, and the step of obtaining includes obtaining a biometric profile representative of a customer's voice or speech.

18. The method of claim 1, wherein said biometric sensing device includes a handwriting recognition device, and the step of obtaining includes obtaining a biometric profile representative of a customer's handwriting.

19. The method of claim 1, further including the step of obtaining a pin code of the customer; and the retrieving step includes retrieving shopping history related information for said customer based on said pin code and said biometric profile.

20. The method of claim 1, wherein the retrieving step includes retrieving payment information of the customer, the method further including the step of storing the payment information for the customer locally so that it is readily available for payment processing during checkout from the retail establishment.

21. The method of claim 20, further including the step of retrieving the locally stored payment information of the customer for payment processing based at least in part upon a biometric profile of the customer obtained by a biometric sensing device at checkout.

22. The method of claim 21, wherein the biometric profile is obtained at a self-checkout system.

23. The method of claim 1, wherein the retrieving step includes retrieving personal information of the customer, the method further including the step of storing the personal information for the customer locally so that it is readily available for processing during checkout from the retail establishment.

24. The method of claim 23, further including the step of retrieving the locally stored personal information of the customer for processing age-restricted purchases or validating customer identity based at least in part upon a biometric profile of the customer obtained by a biometric sensing device at checkout.

25. The method of claim 24, wherein the biometric profile is obtained at a self-checkout system.

26. A system for biometrically identifying a customer of a retail establishment to facilitate or enhance the customer's shopping experience, comprising:
a biometric sensing device adapted to convert a biometric characteristic of a customer of the retail establishment into a representative biometric profile; and
a computer coupled to said biometric sensing device and adapted to retrieve shopping history related information for said customer based on said biometric profile and provide the customer with one or more items that facilitate or enhance the customer's shopping experience, the one or items based on the shopping history related information.

27. The system of claim 26, further including an output device adapted to output said one or more items, said one or more items including one or more manufacturer or retail establishment coupons.

28. The system of claim 27, wherein said output device is a coupon printer and said coupons are physical coupons.

29. The system of claim 27, wherein said output device is a wireless transmitter and said coupons are electronic coupons.

30. The system of claim 26, further including an output device adapted to output said one or more items, said one or more items including a personal shopping list.

31. The system of claim 30, wherein said output device is a printer and said personal shopping list is a physical, printed shopping list.

32. The system of claim 30, wherein said output device is an infrared transmitter and said personal shopping list is an electronic shopping list.

33. The system of claim 26, wherein said output device is adapted to output a retail establishment map showing physical locations of items of a personal shopping list in the retail establishment.

34. The system of claim 26, wherein said output device is adapted to output a personal shopping list including location information indicating where in a retail establishment items of a personal shopping list are located.

35. The system of claim 26, wherein said biometric sensing device includes a fingerprint recognition device.

36. The system of claim 26, wherein said biometric sensing device includes a hand geometry recognition device.

37. The system of claim 26, wherein said biometric sensing device includes a handprint recognition device.

38. The system of claim 26, wherein said biometric sensing device includes an iris recognition device.

39. The system of claim 26, wherein said biometric sensing device includes a face recognition device.

40. The system of claim 26, wherein said biometric sensing device includes a voice or speech recognition device.

41. The system of claim 26, wherein said biometric sensing device includes a handwriting recognition device.

42. The system of claim 26, further including a pin code entering device for obtaining a pin code of the customer, and said computer adapted to retrieve shopping history related information for said customer based on said pin code and said biometric profile.

43. The system of claim 26, wherein said computer is adapted to retrieve and store payment information of the customer so that it is readily available for payment processing during checkout from the retail establishment.

44. The system of claim 26, wherein the computer is adapted to deliver the stored payment information of the customer for payment processing based at least in part upon a biometric profile of the customer obtained by a biometric sensing device at checkout.

45. The system of claim 26, wherein said computer is adapted to retrieve and store personal information of the customer so that it is readily available for processing age-restricted purchases or validating customer identity during checkout from the retail establishment.

46. The system of claim 26, wherein the computer is adapted to use a personal shopping list obtained from said customer and/or said shopping history related information to provide customer relationship management.

47. The system of claim 26, wherein the computer is adapted to use a personal shopping list obtained from said customer for pulling low-touch items of said personal shopping list from shelves of the retail establishment for a customer.

48. The system of claim 26, wherein said computer comprises a computer at a customer identification station, a biometric registration station, an attendant station, a backroom server center, or a self-checkout station.

49. A method of registering a biometric characteristic and identifying a customer, comprising:
registering a biometric characteristic of a customer comprising the steps of:
obtaining a biometric profile representative of a biometric characteristic of a customer using a biometric sensing device;
obtaining payment information from said customer;
associating and storing said biometric profile and payment information for said customer;
biometrically identifying the customer to facilitate or enhance the customer's shopping experience comprising the steps of:
obtaining a biometric profile representative of a biometric characteristic of a customer using a biometric sensing device;
retrieving shopping history related information for said customer based on said biometric profile;
providing the customer with one or more coupons, a shopping list that may indicate the physical location of shopping list items in the retail establishment, and/or a map indicating the physical location of shopping list items in the retail establishment to facilitate or enhance the customer's shopping experience.

50. The method of claim 49, wherein registering a biometric characteristic of a customer occurs at a biometric registration station or a customer service center.

51. The method of claim 49, wherein biometrically identifying the customer occurs at a customer identification station.

52. The method of claim 49, wherein registering a biometric characteristic of a customer and biometrically identifying the customer occurs at the same station.

53. A method of registering a biometric characteristic, identifying a customer, and checkout at a retail establishment, comprising:
registering a biometric characteristic of a customer comprising the steps of:
obtaining a biometric profile representative of a biometric characteristic of a customer using a biometric sensing device;
obtaining payment information from said customer;
associating and storing said biometric profile and payment information for said customer;
biometrically identifying the customer to facilitate or enhance the customer's shopping experience comprising the steps of:
obtaining a biometric profile representative of a biometric characteristic of a customer using a biometric sensing device;
retrieving shopping history related information for said customer based on said biometric profile;
providing the customer with one or more coupons, a shopping list that may indicate the physical location of shopping list items in the retail establishment, and/or a map indicating the physical location of shopping list items in the retail establishment to facilitate or enhance the customer's shopping experience;
biometrically checking out of the retail establishment comprising the steps of:
obtaining a biometric profile representative of a biometric characteristic of the customer using a biometric sensing device;
retrieving payment information for said customer based on said biometric profile; and
paying for one or more items using said payment information.

54. The method of claim 53, wherein registering a biometric characteristic of a customer occurs at a biometric registration station or a customer service center.

55. The method of claim 53, wherein biometrically identifying the customer occurs at a customer identification station.

56. The method of claim 53, wherein registering a biometric characteristic of a customer and biometrically identifying the customer occurs at the same station.

57. The method of claim 53, wherein biometrically checking out of the retail establishment occurs at a self-checkout system.
